(19) United States
(12) Patent Application Publication
(10) Pub. No.: US 2010/0207888 A1
(43) Pub. Date: Aug. 19, 2010

(54) SYSTEM AND METHOD FOR USING A KEYBOARD WITH A TOUCH-SENSITIVE DISPLAY

(75) Inventor: Noam Camiel, Tel Aviv (IL)

Correspondence Address: NOAM CAMIEL, 17 NAHLIEL STREET, TEL-AVIV, 65609, IL

(73) Assignee: Mr. Noam Camiel, Tel Aviv (IL)

(21) Appl. No.: 12/706,669

(22) Filed: Feb. 16, 2010

Related U.S. Application Data
(60) Provisional application No. 61/153,297, filed on Feb. 18, 2009.

(51) Int. Cl. G06F 3/02

(52) U.S. Cl. 345/168

(57) ABSTRACT

A system and method is introduced for using a physical keyboard with a computing device that has a display which may be a touch sensitive display. In the preferred embodiment the keyboard may be situated on top of the display covering part of the display or rotated behind the display allowing the entire display to be used. When the keyboard is placed over part the display the computing device automatically resizes the displayed information according to the visible part of the display and when the keyboard is rotated to the back of the device the computing device resizes the displayed information to make use of the entire display. The preferred embodiment provides a natural intuitive way to use a physical keyboard with a touch screen device in a similar manner to the operation of virtual keyboards on such devices.

### CROSS-REFERENCE TO RELATED APPLICATIONS

This application claims the benefit of U.S. Provisional Patent Ser. No. 61/153,297, filed Feb. 18, 2009 by the present inventor.

### FIELD OF INVENTION

This invention generally relates to computing devices that may use a keyboard for allowing a user to enter data and more particularly but not exclusively to computing devices having a touch screen that may also make use of a keyboard for allowing a user to enter data.

### BACKGROUND OF THE INVENTION

Computing devices with touch sensitive displays have become common following the introduction of the iPhone and iPod Touch by Apple (www.apple.com) among many others. These devices which present an intuitive user interface using touch sensitive displays have the disadvantage that typing is difficult using a virtual keyboard that typically appears on the touch sensitive screen for typing. The reason for the typing difficulty is that pressing a flat display is not similar to pressing actual buttons. While this matter is not critical in mobile phones where relatively small amounts of data is required to be entered, when it comes to a computer or an intermediate computing device such as a tablet or even laptops, the requirement for a physical keyboard exists. The requirement for a physical keyboard grows as larger amounts of data is required to be typed in as well as when data needs to be typed in without looking at the keyboard, for example typing notes during a lecture.

The currently existing touch sensitive devices usually present a virtual keyboard that pops up when keyboard information needs to be typed in by the user. When this occurs a portion of the screen is allocated for the virtual keyboard. The rest of the running applications (or single running application) becomes aware of the allocated space for the virtual keyboard and these applications decrease their size so as to allow room for the virtual keyboard.

The present invention introduces a physical keyboard for touch screen devices that operates in a manner that resembles a virtual keyboard that pops up when data is required to be entered. This may allows the user to choose either to use the virtual keyboard to type in data or to use the physical keyboard.

There is thus a widely recognized need for a way to integrate a physical keyboard with a computing device that has a touch sensitive display.

### SUMMARY OF THE INVENTION

The present invention integrates a physical keyboard with a computing device that has a display which may be a touch sensitive display. The present invention allows the physical keyboard to be situated on top of the display covering part of the display. When the keyboard is placed over part of the display the image on the display changes according to the area covered over by the keyboard. This behavior is similar to a virtual keyboard popping up and taking up area on the screen while other running applications resize themselves as a result of the virtual keyboard popping up.

Furthermore, according to one aspect of the present invention there is provided a physical keyboard coupled to a computing device said keyboard is capable of being placed over part of display of said computing device in a manner that blocks part of said display from view said computing device receiving indication from a sensor when said keyboard is placed over part of said display said computing device adjusts displayed data on said display according to said blocked part of said display following said indication from said sensor.

According to a second aspect of the present invention there is provided a method for using a physical keyboard with a computing device the method comprising: placing said keyboard over part of display of said computing device in a manner that blocks part of said display from view; indicating to said computing device when said keyboard is being placed over part of said display; adjusting image displayed on said display according to said blocked part of said display following receiving said indication of said keyboard being placed over part of said display.

According to a third aspect of the present invention there is provided a computing system comprising: a computing device capable of carrying out computations; a display capable of displaying information; a keyboard capable of being placed over part of said display blocking part of said display from view, a sensor indicating to said computing device when said keyboard is placed over part of said display whereby said keyboard is placed over part of said display said sensor indicates said keyboard is placed over part of said display to said computing device said computing device adjusts information displayed on said display according to blocked part of said display.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a block diagram illustration of a computing device with a touch sensitive display coupled to a physical keyboard where the keyboard is placed under the touch sensitive display, in accordance with an embodiment of the present invention;

FIG. 1B is a block diagram illustration of a computing device with a touch sensitive display and a physical keyboard where a virtual keyboard is being used and a physical keyboard is placed under the touch screen display, in accordance with an embodiment of the present invention;

FIG. 1C is a block diagram illustration of a computing device with a touch sensitive display and a physical keyboard where the keyboard is placed on top of part of the touch sensitive display, in accordance with an embodiment of the present invention;

FIG. 2A is a block diagram illustration of a computing device with a touch sensitive display coupled to a physical keyboard placed in perpendicular to the display in a working mode similar to a laptop, in accordance with an embodiment of the present invention;

FIG. 2B is a block diagram illustration of a computing device with a touch sensitive display and a physical keyboard where the keyboard is placed on top of part of the touch sensitive display, in accordance with an embodiment of the present invention;

FIG. 2C is a block diagram illustration of a computing device with a touch sensitive display coupled to a physical keyboard where the keyboard is placed behind the touch sensitive display, in accordance with an embodiment of the present invention;

FIG. 2D is a block diagram illustration of a computing device with a touch sensitive display coupled to a physical keyboard where the keyboard is placed below the touch sensitive display, in accordance with an embodiment of the present invention;

FIG. 3A is a block diagram illustration of a computing device with a touch sensitive display and a physical keyboard held by two arms, in accordance with an embodiment of the present invention;

FIG. 3B is a block diagram illustration of a computing device with a touch sensitive display and a physical keyboard held by two arms in a working mode where the keyboard is placed on top of part of the touch sensitive display, in accordance with an embodiment of the present invention;

FIG. 3C is a block diagram illustration of a computing device with a touch sensitive display and a physical keyboard held by two arms in a working mode where the keyboard is placed under the touch sensitive display, in accordance with an embodiment of the present invention;

FIG. 4A is a block diagram illustration of the back of a computing device with a touch sensitive display with a surrounding frame holding an adjustable folded physical keyboard and an adjustable closed stand, in accordance with an embodiment;

FIG. 4B is a block diagram illustration of the a computing device with a touch sensitive display with a surrounding frame holding an adjustable open stand and an adjustable open physical keyboard placed over part of the display, in accordance with an embodiment of the present invention;

FIG. 5A is a schematic flowchart for steps carried out when physical keyboard is being placed over part of the computing device display, in accordance with an embodiment of the present invention;

FIG. 5B is a schematic flowchart for steps carried out when physical keyboard is being removed from being placed over part of the computing device display, in accordance with an embodiment of the present invention;

It will be appreciated that, for simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated among the figures to indicate corresponding or analogous elements.

### DESCRIPTION OF THE PREFERRED EMBODIMENTS

The preferred embodiments teach an autonomous computing device with a physical keyboard capable being used in accordance with a touch sensitive display. Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention includes several embodiments that can be realized using the physical keyboard along with a touch sensitive display described herein. In this disclosure, an autonomous computing device with touch sensitive display is coupled to a physical keyboard capable of being used in accordance with the touch sensitive display in several manners or to be placed aside not to be used at all when exclusive use of the touch sensitive display is desired. A computing device with a touch sensitive display may have the functionality of a virtual keyboard that pops up on the touch sensitive display when data is required to be typed in by the user. The presented physical keyboard for the touch sensitive computing device may remain hidden for example behind the computing device screen, or the user can change its position and place it on top of the touch sensitive display covering a part of the touch sensitive display in a similar manner to the way a virtual keyboard takes up a part of the visible screen. The physical keyboard allows the use of a physical keyboard to type in data while part of the display is viewable. The keyboard can be put away for the touch screen display to be used exclusively. When the keyboard is placed on top of the touch sensitive device for use with the touch sensitive device, the computing device becomes aware of the keyboard being positioned on top of part of the display causing the current applications executing on the computing device to adjust their size accordingly and to use only the current visible part of the display left uncovered by the physical keyboard.

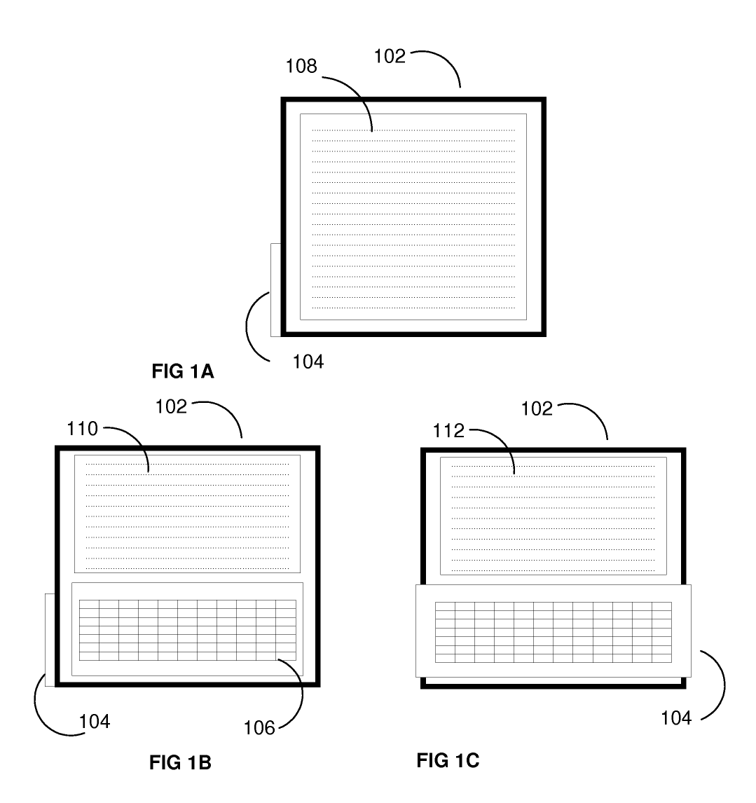

In FIGS. 1A, 1B and 1C a single exemplary computing device with a touch sensitive display coupled to a physical keyboard is shown in different modes of operation where the physical keyboard may be placed behind the display for use of the entire display or the physical keyboard may be placed on top of the display hiding a part of the screen for entering data using the keyboard and viewing a part of the screen.

Reference is now made to FIG. 1A, which is a block diagram illustration of a computing device with a touch sensitive display coupled to a physical keyboard where the keyboard is placed under the touch sensitive display, in accordance with an embodiment of the present invention comprising a touch sensitive display 102 which may be fully or partially touch sensitive, a keyboard 104 capable of being placed in different positions relative to the display. In the preferred embodiment the keyboard 104 may be situated behind the display 102 when not in use. In this mode the entire display may be used to view as well as enter data using the touch sensitive display as displayed in FIG. 1A by the entire viewable information on the screen 108. The computing device in this and the rest of the figures is not shown and may be placed with the display or keyboard for example.

Reference is now made to FIG. 1B, which is a block diagram illustration of a computing device with a touch sensitive display and a physical keyboard where a virtual keyboard is being used and a physical keyboard is placed under the touch screen display, in accordance with an embodiment of the present invention comprising display 102, and keyboard 104 as described in image 1A. In this fig. a virtual keyboard 106 pops on the touch screen to enter data and takes up area on part of the display 102. Accordingly the application size that was using the entire display 108 of FIG. 1A is resized to available display size 110 without the size taken up by virtual keyboard 106.

Reference is now made to FIG. 1C, which is a block diagram illustration of a computing device with a touch sensitive display and a physical keyboard where the keyboard is placed on top of part of the touch sensitive display, in accordance with an embodiment of the present invention comprising display 102 and keyboard 104 as described in image 1A. In this fig. the physical keyboard 104 is placed on top of display 102 which can be fully or partially touch sensitive. The computing device becomes aware of the placement of the keyboard on its display, for example through sensors on the display or through hinges that include sensors and may connect physical keyboard to computing device in some embodiments. As a result the computing device may resize the appearing applications on the display to the available display size left uncovered 112 by physical keyboard. The resizing of the displayed information on the screen may occur in a similar manner to the way the application is adjusted in FIG. 1B when virtual keyboard 106 appears. In some embodiments the size of the virtual keyboard 106 and space taken up by physical keyboard 104 when placed over display 102 may be the same. When the keyboard is folded away the displayed information may be resized to use the entire screen. The sensors that communicate the location of the keyboard in respect to the display screen may be located for example on the keyboard back, in hinges connecting the keyboard to the body of the computing device or through other means. When the sensors indicate the keyboard is placed over a part of the display a command may be issued by a program in the computing device or through the keyboard to resize the display on the screen according to the unobstructed area left on the screen and the opposite when the keyboard is removed from the top of the display screen. In some embodiments a virtual keyboard of the size of the hidden part of the display may be triggered as a result of the placing of the keyboard on top of the screen for example by a program installed on the computing device or by the keyboard.

The computing device in FIGS. 1A, 1B and 1C presents a physical keyboard which can be repositioned according to user requirements and be used to enter data through the physical keyboard and partial viewable display, or the keyboard can be put away so that the entire display is used for viewing and entering data by the user. When the keyboard changes its position the computing device changes the displayed information of the currently running applications to the user according to the displayed area that is not hidden by the keyboard. For instance, when the keyboard changes from FIG. 1C to FIG. 1A, the computing device resizes the applications or other data viewable to the user in a manner that the entire display may be used. When the keyboard changes from FIG. 1A to FIG. 1C, the computing device resizes the applications or other data viewable in a manner that only the visible portion of the display may be used. This behavior resembles the use of a virtual keyboard with touch screen devices which pop up when needed and disappear when not needed. Just like the virtual keyboard pops up and causes the display to resize the applications on the screen to make room for the virtual keyboard so does the physical keyboard work in the same way when placed over part of the display making the behavior natural and as common to virtual displays. In fact a virtual desktop as in FIG. 1B or the physical desktop as in FIG. 1C may be used as chosen by the user and the operation of the computing device would be the same from the user perspective. This resemblance between the operation of a virtual keyboard and the physical keyboard is one of the advantages of the present invention. The physical keyboard may be used and put away easily similarly to the use of a virtual keyboard. Furthermore no dock is required for the use of the keyboard.

As was shown in FIGS. 1A, 1B and 1C, applications that execute on the computing device may be automatically resized according to the viewable area of the display and information may be entered by the user through the viewable area of the display and through the keyboard when the keyboard is not placed behind the display. In this manner a computing device may be used with a physical keyboard or without it according to the requirements of the user executing applications on the computing device. One of the advantages of such a keyboard is that it may be portable and always ready for use as well as to be put away. This is in contrast to keyboards that may be used with a dock station for example.

In some embodiments the keyboard may be connected to the computing device by hinges and rotate behind and in front the computing device display. In some embodiments the keyboard 104 may be connected through a connector to the computing device. In some embodiments keyboard 104 may connect to the computing device wirelessly such as using Bluetooth.

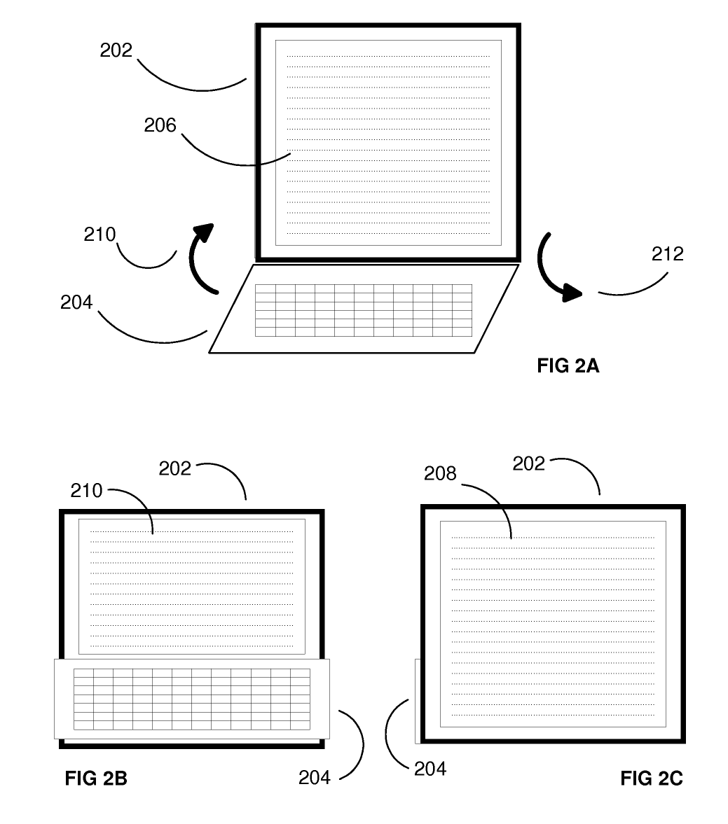

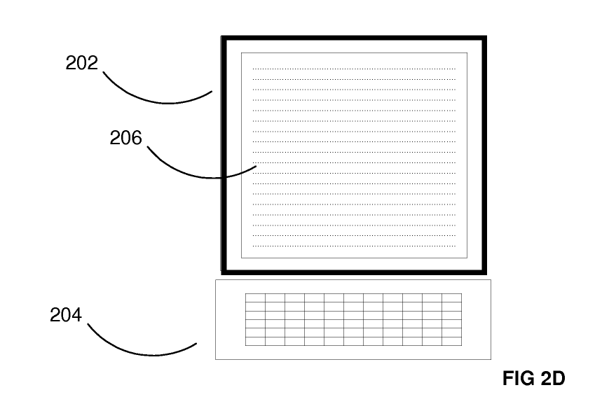

In FIGS. 2A, 2B, 2C and 2D a single exemplary computing device with a touch sensitive display coupled to a physical keyboard is shown in different modes of operation where the physical keyboard may rotate and be placed behind the display as in FIG. 2C for use of the entire display; the keyboard may be placed below the display as in FIG. 2D for using the keyboard and the entire display; the keyboard may be placed in perpendicular to the display as in FIG. 2A resembling a laptop; the physical keyboard may be placed on top of the display as in FIG. 2B hiding part of the display screen for entering data using the keyboard and viewing a part of the screen. The preferred embodiment allows integrating a keyboard with a touch sensitive display of a computing device in a manner that applications running on the computing device change their behavior on the display in relation to the use of the keyboard.

Reference is now made to FIG. 2A, which is a block diagram illustration of a computing device with a touch sensitive display coupled to a physical keyboard placed in perpendicular to the display in a working mode similar to a laptop, in accordance with an embodiment of the present invention comprising display 202 and coupled keyboard 204. The keyboard 204 may rotate towards the display as is displayed by arrow 210 and be placed on top of the display covering a part of the display as is displayed in FIG. 2B. When in the mode of FIG. 2B, information from the keyboard and from the visible part of the display can be used by the user. The keyboard 204 may rotate away from the display as shown by arrow 212 as is displayed by FIG. 2C. In the mode of FIG. 2C the keyboard is put away and the entire display is visible to the user. In FIG. 2A the coupled keyboard is placed in perpendicular to the display allowing the use of the entire area of the display as shown by full display 206. This mode of operation resembles a laptop.

Reference is now made to FIG. 2B, which is a block diagram illustration of a computing device with a touch sensitive display and a physical keyboard where the keyboard is placed on top of part of the touch sensitive display, in accordance with an embodiment of the present invention comprising display 202 and coupled keyboard 204. The keyboard is placed on part of the display 202 leaving only area 210 of the display visible for viewing application data as well as to use that area of the touch screen. As in FIG. 1C, the computing device senses the fact that the keyboard is placed on part of it for example using sensors placed on computing device not shown in the fig. Such sensors appear for example in laptops sensing when the laptop is folded such that the screen is folded with the laptop keyboard. Similarly to FIG. 1C the displayed application or applications are adjusted by the computing device to fit in the visible area 210 as the mode is changed to the mode in FIG. 2B. When the keyboard is moved from the state in FIG. 2B and the entire screen may be used again the computing device becomes aware of this, for example using the above mentioned sensors and the computing device resizes the applications or the image on the screen or other data viewable to the user in a manner that the entire display may be used.

Reference is now made to FIG. 2C, which is a block diagram illustration of a computing device with a touch sensitive display coupled to a physical keyboard where the keyboard is placed behind the touch sensitive display, in accordance with an embodiment of the present invention comprising display 202 physical keyboard 204 that is placed behind display 202 and entire visible display area for application use 208. In this mode the entire display may be used for application use as in FIG. 1A. The keyboard is rotated as in arrow 212 away from the display placed behind the display.

Reference is now made to FIG. 2D, which is a block diagram illustration of a computing device with a touch sensitive display coupled to a physical keyboard where the keyboard is placed below the touch sensitive display, in accordance with an embodiment of the present invention comprising display 202 and coupled keyboard 204. The coupled keyboard is placed below the display leaving the entire display area 206 for application use. The keyboard may be rotated by the user and placed directly below the display. The user may rotate the keyboard such that the display may be raised and the keyboard in an angle to the display.

The computing device in FIGS. 2A, 2B 2C and 2D presents a physical keyboard which can be repositioned according to user requirements and be used to enter data as a laptop, a keyboard with part of the screen for entering data through the keyboard and using the partial viewable display, or the keyboard can be put away so that the entire display is used for viewing and entering data by the user.

In some embodiments the keyboard may rotate such that hinges are placed allowing the keyboard to rotate. In some embodiments the keyboard 104 may have a keys on both sides of the keyboard piece so that the keyboard may be physically attached at the bottom of the display screen and be either used as a laptop with one side of the keyboard, and when turning the keyboard towards the display as in arrow 210, the other side of the keyboard is viewable and usable. In some embodiments a different set of keys may be used on either side of the keyboard 104. In some embodiments the keyboard may be split so that only a part of the keyboard used in the laptop mode for example is placed on top of the display screen. For example a large keyboard may be used in laptop mode but when the keyboard is folded on top of the display screen a smaller size keyboard is folded from laptop mode keyboard and placed on top of the display leaving more of the display visible and allowing easier handling, for example for use with one hand.

In some embodiments keyboard 104 may have only one side of keys and the keyboard 104 may rotate according to its required side, such as displayed in image 3A.

In some embodiments the keyboard may be placed in different places on the screen covering different parts of the display. This may be done for instance by allowing the keyboard to physically be placed in different locations over the display or by a keyboard capable of growing and shrinking. The keyboard may for example be a sliding keyboard so that the amount of covered area of the screen may change according to user preference. For all these cases a sensor may indicate to the computing device the area that is covered by the keyboard and the computing device may adjust the displayed image on the screen according to the covered portion. In some embodiments the sensor may be the display itself. In some embodiments the keyboard may be moved over the screen and the display adjusts the image according to the current location of the keyboard. In such cases as above, a sensor or the display itself for example can indicate the location of the keyboard to the computing device that in turn adjusts the displayed image on the screen according to the obstructed area of the display by the keyboard.

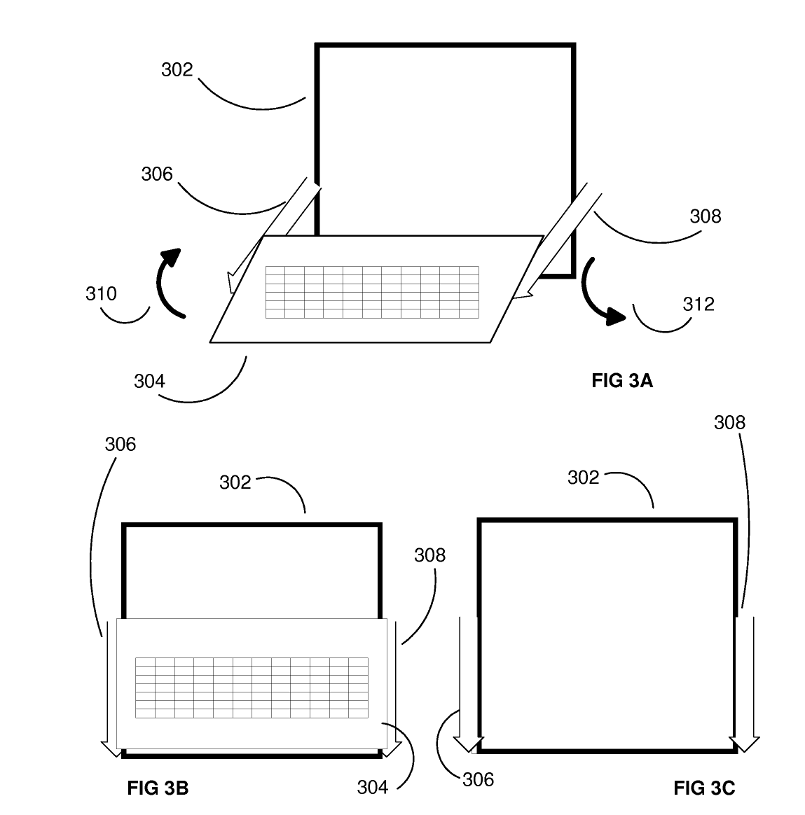

Reference is now made to FIG. 3A, which is a block diagram illustration of a computing device with a touch sensitive display and a physical keyboard held by two arms, in accordance with an embodiment of the present invention comprising a touch sensitive display 302 which can be fully or partially touch sensitive, a keyboard 304 capable of being placed in different positions relative to the display. The computing device further comprises two arms 306 and 308 on each side of the display which hold the keyboard and allow it to rotate and move so that it may be situated in different modes. These modes include a laptop mode where the keyboard is placed perpendicular to the display 102; a mode where the keyboard may be rotated to the direction of arrow 312 against the direction of the screen and the arms be moved towards arrow 310 towards the display so that the keyboard is located on top of the display as shown in FIG. 3B; a mode where the arms are moved behind the display to the direction of arrow 312 against the display and the keyboards is rotated in the direction of arrow 310 towards the display to be kept behind the display. Information from the keyboard and from the unhidden portion of the display can be used to enter information by the user. In this manner it may be possible to use a keyboard with keys only on one of its sides and allow the keyboard to be situated in these above mentioned modes.

Reference is now made to FIG. 3B, which is a block diagram illustration of a computing device with a touch sensitive display and a physical keyboard held by two arms in a working mode where the keyboard is placed on top of part of the touch sensitive display, in accordance with an embodiment of the present invention comprising similarly to FIG. 3A a touch sensitive display 302 which can be fully or partially touch sensitive, and keyboard 304 capable of being placed in different positions relative to the display. The device further comprises arms 306 and 308 on each side of the display holding the keyboard and allowing it to be rotated and moved. In the preferred embodiment the keyboard 304 may be situated by the user on top of the display covering a part of the display. In this mode, information from the keyboard and from the unhidden part of the display can be used to enter information by the user. In the preferred embodiment the computing device is aware of the keyboard being placed over part of the screen for example using sensors or small switches and automatically resizes the displayed information on the screen according to the current visible display size.

Reference is now made to FIG. 3C, which is a block diagram illustration of a computing device with a touch sensitive display and a physical keyboard held by two arms in a working mode where the keyboard is placed under the touch sensitive display, in accordance with an embodiment of the present invention comprising similarly to FIG. 3A a touch sensitive display 302 which can be fully or partially touch sensitive, and keyboard unseen in this figure as it is placed under the display. The device further comprises arms 306 and 308 on each side of the display holding the keyboard and allowing it to be rotated and moved. In the preferred embodiment the keyboard can be situated by the user behind the display. In this mode, the entire display is being used by the user to input data and view the running applications of the computing device. The computing device is not shown in the figure and may be placed with the display or keyboard.

The computing device in FIGS. 3A, 3B and 3C presents a keyboard which can be repositioned according to user requirements and be used to enter data as a laptop, a keyboard with part of the screen visible for entering data through the keyboard and partial viewable display, or the keyboard can be put away so that the entire display is used for viewing and entering data by the user. The keyboard may have keys only on one side of the keyboard. The arms may allow the keyboard to move and rotate according to FIGS. 3A, 3B and 3C where the keyboard can be used in FIGS. 3A and 3B and be hidden as in FIG. 3C.

In some embodiments the arms holding the keyboard allow the keyboard to rotate around as well as move in towards the screen and out away from the screen.

In some embodiments applications or other computer related information may change according to the position of the keyboard in an automatic fashion. For example when the keyboard is unused some other information may be displayed as to when the keyboard is used. Display information may change according to visible area of display etc.

In some embodiments the keyboard may slide from the back of the device down until it is completely pulled out. The keyboard may then slide up in front of the device on the screen. The keyboard may be used in both manners in some embodiments.

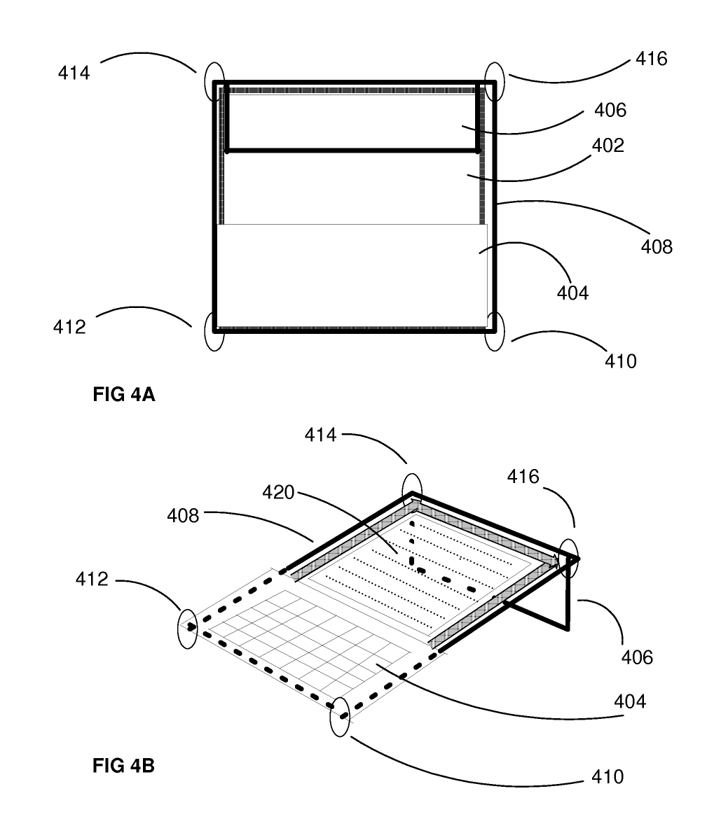

Reference is now made to FIG. 4A, which is a block diagram illustration of the back of a computing device with a touch sensitive display with a surrounding frame holding an adjustable folded physical keyboard and an adjustable closed stand, in accordance with an embodiment of the present invention comprising back of computing device 402 and surrounding frame 408 placed around the computing device. The frame holds adjustable physical keyboard 404 through hinges 410 and 412 on the bottom of the computing device. The hinges allow the keyboard to be rotated and placed on top of the display. The frame further holds adjustable stand 406 through hinges 414 and 416 on top of the computing device. The stand may be rotated and opened to rest the computing device on it. The keyboard and stand are folded at the back of the computing device allowing the use of the entire display not shown in FIG. 4A.

Reference is now made to FIG. 4B, which is a block diagram illustration of the a computing device with a touch sensitive display with a surrounding frame holding an adjustable open stand and an adjustable open physical keyboard placed over part of the display, in accordance with an embodiment of the present invention comprising front display of computing device 420 and surrounding frame 408 placed around the computing device. The frame holds adjustable physical keyboard 404 through hinges 410 and 412 on the bottom of the computing device. The hinges allow the keyboard to be rotated and placed on top of the display. In the current fig. the keyboard is open and placed over part of the display. The frame further holds adjustable stand 406 through hinges 414 and 416 on top of the computing device. The stand is opened in this fig and may be rotated and closed. In this fig. the keyboard and stand are opened. The computing device rests on the stand. The keyboard hides a part of the display closely resembling a virtual keyboard taking up a part of the display area when used. In the preferred embodiment the computing device becomes aware of the open keyboard for example by sensors placed in the hinges 410 or 412 or through other sensors that may be placed on the computing device such as those sensing when a laptop lid is closed. The computing device adjusts the displayed information according to the area on the display left unobstructed by the keyboard. In this manner a keyboard may be used, and then folded away. The display is adjusted automatically when the keyboard is placed on the display and when it is folded and removed from the top of the display. In this case when the keyboard is folded and more room becomes available for display, the computing device may use that room by adjusting the visible information on the display.

In FIG. 4B the dashed black line represents obstructed frame and stand hidden by keyboard and computing device. The frame may be placed on computing device and taken off as an accessory and need not be an integral part of the computing device. The computing device border is indicated by a thick border within the surrounding frame. In some embodiments the keyboard and stand may be placed in portrait and in other embodiments in landscape. The keyboard may connect to computing device through different means for example a cable, wireless such as Bluetooth etc. The embodiment in FIGS. 4A and 4B may allow a portable device that may be easily carried and moved around and used to type data when on the move.

In some embodiments no stand is used and only the keyboard 404 is used. In some embodiments the stand may be completely removed and returned later. In some embodiments the keyboard may be completely removed and returned later. In some embodiments other items may be added such as a protective cover.

In some embodiments the keyboard may be put aside in different manners than being folded to the back of the computing device. For example, the keyboard may be inserted into the computing device like a drawer and pulled out when required. A special place for the keyboard in this case needs to be prepared in the computing device. The keyboard may be folded or placed in different locations on the computing device or may be separated from the computing device completely. In some embodiments the physical keyboard may be an optional accessory and it is not required that it would be a part of the computing device. for example in FIGS. 4A, and 4B the frame 408 with the keyboard 404 and stand 406 may be an accessory that may be placed on or removed from the computing device as desired. In other embodiments the physical keyboard may be an integral part of the computing device.

In some embodiments the physical keyboard may be used in conjunction to the virtual keyboard even without any sensors indicating when the keyboard is placed over part of the display screen. This may be possible when the physical keyboard is the size of the virtual keyboard or smaller. When the virtual keyboard pops up the physical keyboard may be placed on top of it since the display adjusts according to the display area not occupied by the virtual keyboard.

In some embodiments of the present invention the physical keyboard indicates to the computing device to adjust the display according to the visible area of the screen following the physical keyboard blocking a part of the screen. The issue of indicating the required display adjustment may be done in various ways and may in some embodiments be done according to the way a virtual keyboard pops up. In some embodiments of computing devices with touch screens the virtual keyboard may pop up when an editable field is being pressed upon. The virtual keyboard may disappear when the user completes to edit the editable field such as by pressing a done button or a similar button. The physical keyboard may imitate this behavior of the virtual keyboard by signaling to the computing device a touch in the first or in the main editable field for example when the physical keyboard is placed over part of the display screen and the same may be done when the keyboard is removed from the top of the display, by imitating pressing the above mentioned done button. In some embodiments a physical keyboard may work in conjunction to a virtual keyboard operation so that the computing device is not aware of the physical keyboard which is being used when the virtual keyboard is used. If the physical keyboard is of similar size or smaller than the virtual keyboard then the display on the screen may be sufficient for using the physical keyboard in this manner.

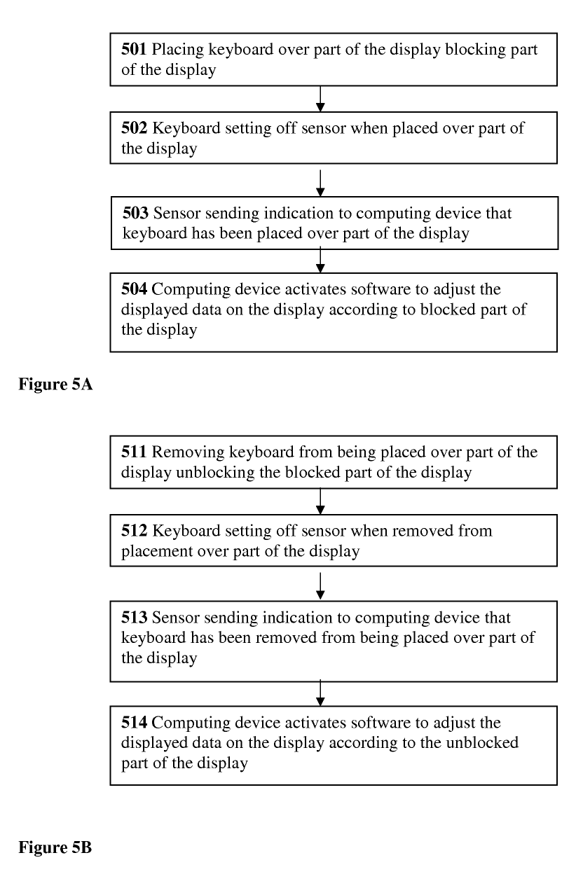

Reference is now made to FIG. 5A, which is a schematic flowchart for steps carried out when physical keyboard is being placed over part of the computing device display, in accordance with an embodiment of the present invention;

In step 501, the physical keyboard is placed over part of the display blocking part of the display.

In step 502, the keyboard sets off sensor when it is placed over part of the display.

In step 503, the sensor sends indication to the computing device that the keyboard has been placed over part of the display. In some embodiments this indication may include the exact part of the display that the keyboard is placed over.

In step 504, the computing device activates software running within computing device to adjust the displayed data on the screen according to the blocked part of the display. This may be similar to how the computing device adjusts the screen when a virtual keyboard pops up. In some embodiments this may be done in hardware in addition to software, in hardware only or in other manners.

These series of steps displays how a physical keyboard may be placed over part of the display of a computing device causing the displayed data on the display to change according to the area of the screen that the physical keyboard covers.

Reference is now made to FIG. 5B, which is a schematic flowchart for steps carried out when physical keyboard is being removed from being placed over part of the computing device display, in accordance with an embodiment of the present invention;

In step 511, the physical keyboard is removed from its previous placement over part of the display unblocking the view of the previously blocked part of the display.

In step 512, the keyboard sets off sensor when it is removed from its placement over part of the display.

In step 513, the sensor sends indication to the computing device that the keyboard has been removed from its placement over part of the display.

In step 514, the computing device activates software running within computing device to adjust the displayed data on the screen according to the unblocked part of the display. This may be similar to how the computing device adjusts the screen when a virtual keyboard is removed and pops down. In some embodiments this may be done in hardware in addition to software, in hardware only or in other manners.

These series of steps displays how a physical keyboard may be removed from placement over part of the display of a computing device causing the displayed data on the display to change according to the area of the screen that the physical keyboard uncovers.

It may be appreciated by those skilled in the art of the present invention that a computing device with a touch screen display may make use of a physical keyboard in a way that closely resembles how a virtual keyboard is used which is a natural way of using a keyboard with such devices. Furthermore a computing device with a touch screen display may make use of a physical keyboard in a flexible manner or to be put away when it is not needed. The preferred embodiments provide a portable solution and a flexible one for ease of typing data into the computing device. The physical keyboard presented allows a flexible solution allowing to use the keyboard when needed and to move it from the display when it is not needed. The present invention allows making use of the physical keyboard in different manners and also allows not to use the keyboard. This invention further allows application size to be adjusted automatically according to the current use of the keyboard. This invention also allows a touch sensitive computing device to serve as a laptop or a handy device with a keyboard for example when on the move or a device for taking notes in class or as a touch screen device only without a keyboard. In such mode where the keyboard is not in use a virtual keyboard may be used in place of the physical keyboard. The preferred embodiment has the following advantages over existing art:
(a) The present invention allows integrating a keyboard with a touch sensitive display of a computing device in a natural intuitive way that is operating in a similar manner to the operation of a virtual keyboard.
(b) The present invention integrates a physical keyboard with a computing device with a touch sensitive display in a manner that applications running on the computing device change their behavior in relation to the use of the keyboard.
(c) The present invention allows a computing device with a touch screen display to make use of a physical keyboard in a flexible manner that can be easily changed by the user.
(d) The present invention allows the use of a portable physical keyboard with a device with a touch screen display.

### CONCLUSION, RAMIFICATIONS AND SCOPE

Accordingly, the reader will see that the disclosure of this invention provides a system and method to make use of a physical keyboard with a computing device that has a touch sensitive display in a natural intuitive way similar to the use of a virtual keyboard in touch screen devices.

Furthermore the closure of this invention has the additional advantages in that:

(a) The user may use the device as a laptop where the keyboard is perpendicular to the display.

(b) The user may use the device using only the touch screen without the keyboard, where the keyboard is folded away.

(c) The user may use the device as a hand held device that has a physical keyboard similarly to how the device is used when the virtual keyboard is used.

(d) The computing device automatically adjusts applications or any other required displayed information on the screen according to the keyboard mode in an automatic fashion.

(e) The physical keyboard may be quickly used and put away as required by the user similar to how a virtual keyboard is used with touch sensitive displays.

(f) No dock is required to use the physical keyboard.

(g) The physical keyboard may be an optional accessory and does not require being a part of the computing device.

(h) The physical keyboard works similarly to a virtual keyboard on the screen.

Although the description above contains many specifications, these should not be constructed as limiting the scope of the invention but as merely providing illustrations of some exemplary embodiments of this invention.

For example, The keyboard may be placed as a drawer within the computing device or folded as opposed to being placed behind the device; a keyboard may be used with keys on both sides to simplify keyboard rotation, a keyboard with keys only on one side may be used; a keyboard with two different set of keys may be used; different methods of placing the keyboard with the display may be applied. The keyboard may be hidden by inserting the keyboard into the device. The keyboard may be placed in a freely set location on the display and the display may sense that location and adjust the display according to the changing location of the keyboard; the keyboard may be sensed by the touch sensitive screen by the use of keys that touch the touch sensitive display; the display does not have to be touch sensitive at all or may be partially touch sensitive and so on.

While certain features of the invention have been illustrated and described herein, many modifications, substitutions, changes, and equivalents may now occur to those of ordinary skill in the art. It is, therefore, to be understood that the appended claims are intended to cover all such modifications and changes as fall within the true spirit of the invention.

It is expected that during the life of this patent many relevant keyboards computing devices and systems will be developed and the scope of the terms herein, particularly of the terms “touch sensitive display” and “keyboard”, as well of the communication between them is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A physical keyboard coupled to a computing device said keyboard capable of being placed over part of display of said computing device in a manner that blocks part of said display from view said computing device receiving indication from a sensor when said keyboard is placed over part of said display said computing device adjusts displayed data on said display according to said blocked part of said display following said indication from said sensor.

2. The physical keyboard of claim 1 wherein said keyboard is removed from covering part of said display in a manner that unblocks said blocked part of said display said computing device receiving removal indication from said sensor when said keyboard is being removed from covering part of said display said computing device adjusts displayed data on said display according to said unblocked part of said display following said removal indication from said sensor.

3. The keyboard of claim 1 wherein said keyboard is moved to another part of said display covering a part of said display wherein said computing device receiving indication using a movement sensor when said keyboard is being moved to another location over part of said display said computing device adjusts displayed data on said display according to said moved location of said keyboard over said display following said movement indication from said movement sensor.

4. The keyboard of claim 2 wherein said keyboard is removed from covering part of said display said display is unobstructed by said keyboard and said keyboard is usable for typing data into computing device.

5. The keyboard of claim 2 wherein said physical keyboard is removed from covering part of said display said display is unobstructed by said keyboard and said keyboard is not usable for typing data into computing device.

6. The keyboard of claim 1 wherein said computing device automatically adjusts data displayed on said display according to unobstructed area of said display by said keyboard said keyboard capable of being placed over part of said display.

7. A method for using a physical keyboard with a computing device the method comprising:
placing said keyboard over part of display of said computing device in a manner that blocks part of said display from view;
indicating to said computing device when said keyboard is being placed over part of said display;
adjusting image displayed on said display according to said blocked part of said display following receiving said indication of said keyboard being placed over part of said display.

8. A method according to claim 7 wherein image displayed on said display is adjusted according to unblocking of said blocked part of said display following receiving indication of said keyboard being removed from said display.

9. A method according to claim 8 wherein image displayed on said display is adjusted according to currently blocked part of said display following receiving indication of said keyboard being moved over a different area of said display.

10. A method according to claim 8 wherein said keyboard is usable following removal of said keyboard from said display.

11. A method according to claim 8 wherein said keyboard is not usable following removal of said keyboard from said display.

12. A method according to claim 7 wherein said computing device automatically adjusts said image displayed on said display according to unobstructed area of said display by said keyboard placed over said display.

13. A computing system comprising:
a. a computing device capable of carrying out computations;
b. a display capable of displaying information;
c. a keyboard capable of being placed over part of said display blocking part of said display from view,
d. a sensor indicating to said computing device when said keyboard is placed over part of said display
whereby said keyboard is placed over part of said display said sensor indicates said keyboard is placed over part of said display to said computing device said computing device adjusts information displayed on said display according to blocked part of said display.

14. The computing system of claim 13 wherein said keyboard is removed from covering part of said display whereby said sensor indicates said keyboard is removed from covering part of said display to said computing device said computing device adjusts information displayed on said display according to uncovered part of said display following receiving said indication from said sensor.

15. The computing system of claim 13 wherein said keyboard is moved to another part of said display covering a part of said display whereby said computing device receiving indication using a movement sensor when said keyboard is moved to another location over part of said display said computing device adjusts information displayed on said display according to covered part of said display following receiving said indication from said movement sensor.

16. The computing system of claim 13 wherein said keyboard is removed from covering part of said display said display is unobstructed by said keyboard and said keyboard is usable for typing data into said computing device.

17. The computing system of claim 13 wherein said keyboard is removed from covering part of said display said display is unobstructed by said keyboard and said keyboard is not usable for typing data into computing device.

18. The computing system of claim 13 wherein said computing device automatically adjusts said display according to unobstructed area of said display by said keyboard when said keyboard is placed over part of said display

19. The computing system of claim 13 wherein said keyboard has keys on both sides of said keyboard.

20. The computing system of claim 13 wherein said keyboard sets focus to an editable field for data entry to said computing device when placing said keyboard over said display.
